(19) United States
(12) Patent Application Publication
(10) Pub. No.: US 2012/0114798 A1
(43) Pub. Date: May 10, 2012

(54) AERATED FOOD PRODUCTS AND METHODS OF MAKING SAME

(76) Inventor: Jeremy Zobrist, Congerville, IL (US)

(21) Appl. No.: 13/290,892

(22) Filed: Nov. 7, 2011

Related U.S. Application Data
(60) Provisional application No. 61/410,836, filed on Nov. 5, 2010.

(51) Int. Cl. A23P 1/16; A23L 1/30; A23L 3/36; A23P 1/10; A23L 3/40; A23L 3/44; A23P 1/12

(52) U.S. Cl. 426/61; 426/474; 426/384; 426/442; 426/444

(57) ABSTRACT

A method of producing a aerated food product which may be frozen, freeze dried, or dried. The method includes providing a raw ingredient composition having a desired first viscosity, aerating the composition to a desired second viscosity with a desired amount of aeration, shaping the aerated composition, and depending on the food product, freezing the shaped aerated composition, freeze-drying the shaped aerated composition or drying the shaped aerated composition.

### BACKGROUND

Aerated freeze-dried, frozen or dried food products are well known in the art. Aeration can provide desirable characteristics such as light, fluffy textures and dissolvability of the product in the consumer's mouth which results in a pleasing oral sensation and rapid flavor transfer to the taste buds. It can also provide pleasing crunchy texture that is desirable for some snacks. The more a product is aerated, the better it will dissolve. When properly freeze-dried or lyophilized, the aerated product can remain on store shelves for months at ambient temperatures while maintaining its shape, texture and flavor. However, the more a product is aerated prior to freeze-drying, freezing or drying, its hardness and physical stability can decrease making it susceptible to fracturing or breaking during shipping and handling.

U.S. patent application Ser. No. 12/482,252 (Pub. No. US2009/0324773) and Ser. No. 12/482,256 (Pub. No. US2009/0304854), both of which are incorporated herein in their entireties by reference, are directed to a freeze-dried dairy or dairy substitute compositions, which rely on emulsifiers and/or viscosity agents as additives to facilitate aeration by lowering surface tension of the composition. The viscosity agents assist in thickening the composition so that it is easier to deposit without dripping and for forming into shapes. The viscosity agent also helps maintain the aeration and shape of the composition prior to freezing. Emulsifiers and viscosity agents are quite expensive and increase production costs due to longer cycle or batch times for the ingredients to set-up or cure, which translates into higher prices for consumers. In addition, many consumers prefer food products with all “natural ingredients” as opposed to food products comprised of various chemical compounds listed on the ingredients label.

Therefore, there is a need for a process for producing an aerated food product, which can be freeze-dried, frozen or dried that has physical stability to minimize fracture and breakup of the product during shipping and handling and which has the desired texture and dissolvability characteristics without the need for the addition of emulsifiers, viscosity agents or other chemical compounds.

### DESCRIPTION

The present invention is directed to an aerated food product that may be freeze-dried, frozen or dried, and which comprises a raw ingredient such as a dairy or dairy substitute ingredient or fruits, vegetables, nuts, grains and meat. As used herein, any reference to food product or food composition should be understood to include both human and animal food products.

The raw ingredient may have to be processed to achieve a suitable viscosity and natural chemical properties to allow entrainment of air. The dairy ingredient may include, but is not limited to, milk, milk powder, yogurt, skim milk and milk proteins or combinations thereof. The dairy substitute ingredient may include, but is not limited to, soy proteins and rice proteins and combinations thereof. The raw ingredients are preferably pasteurized using processes known to those skilled in the art and are preferably present in an amount from 50% to 100% by weight.

The particle matrix or structure of the raw ingredient is preferably reduced by any well recognized viscosity reducing process including, by way of example, a high speed blender, a high-shear pump, homogonizer, etc. The low viscosity raw ingredient is then aerated to achieve a desired viscosity. The aeration process preferably continues until the natural ingredient is whipped, light and airy or otherwise has the texture desired.

In one method of aeration, the low viscosity raw ingredient is deposited into a scrape surface heat exchanger, such as a continuous ice cream freezer or the like, which churns the low viscosity raw ingredient while it is being cooled thereby entrapping or entraining air as the viscosity increases. A preferred scrape surface heat exchanger is a continuous ice cream freezer, such as a APV Crepaco Ice Cream freezer, model no. W-1126. The ice cream freezer is connected to a suitable cooling source, such as liquid ammonia source, to maintain the mixing temperature at 24-34 deg F. The scrape surface heat exchanger, preferably has the capability to bubble nitrogen or other gases or liquids.

In another method of aeration, the low viscosity raw ingredient is deposited into a mixer, such as Mondo™ mixer distributed by Haas-Mondomix B.V., Almere, The Netherlands, such mixers have the capability of adjusting bubble size with various speeds and tip sizes.

In another method of aeration, a gas, such as oxygen or nitrogen may be introduced into the low viscosity raw ingredient. Nitrogen is preferred because it reduces oxidation and increases shelf life. Alternatively, rather than gas, a liquid capable of “flashing” or changing from a liquid to a gas upon contact with the low viscosity raw material (hereinafter referred to as a “flashable liquid”) may be introduced to aerate the low viscosity raw material. The gas or flashable liquid may be introduced by any well know injection process or by using a sintered metal apparatus such as a sparger. A sparger allows precise air entrainment as the bubble size can be directly controlled through the size of the sparger pore size. It should be appreciated that the introduction of gas or flashable liquid may be used separately or in combination with any of the other aeration methods identified herein.

It should also be appreciated that by adjusting the temperature of the gas or flashable liquid aeration and/or bubble size can be controlled. Typically, the greater temperature differential between the gas or flashable liquid and the temperature of the low viscosity raw ingredient, the larger the bubbles that will be created as the gas, vapor or the vapor particles expand when contacting the warmer raw ingredients.

In yet another method, depending on the raw ingredients, operating conditions and temperatures, aeration may be achieved by causing the low viscosity raw ingredient to experience a reduction in pressure, which will cause bubbles in the low viscosity raw ingredient to expand. This reduction in pressure may be performed in a batch process, whereby a vacuum pump evacuates air from a chamber in which the low viscosity raw ingredient is deposited. Alternatively, in a continuous process, the reduction in pressure may be achieved by forcing the raw ingredient through a smaller orifice under pressure into a larger volume where the pressure is less. As the raw ingredient is forced from the smaller volume, higher pressure area into the larger volume, lower pressure area, the gas bubbles in the low viscosity raw ingredient will expand and aerate the low viscosity raw ingredient.

The aerated composition is preferably maintained at or below a temperature to maintain suitable viscosity as it is pumped to be formed or shaped prior to final freezing (if desired). One preferred method of shaping is to distribute to multiple nozzles which, via a metering device, deposits drops, dollops or a desired shape of the aerated composition onto a solid, stainless steel freezer belt. Alternatively the aerated composition may be extruded or molded into any desired shape. The desired shapes may then be conveyed to a dryer tunnel to dry the aerated shaped product or conveyed to a freezer tunnel which further freezes the composition. The dried or frozen shapes may then be freeze-dried or packaged and stored for later freeze drying, or packaged and shipped.

Freeze drying also known as lyophilization is a drying process where a frozen product is subjected to a vacuum and the frozen ice crystals sublimate. The direct phase change from solid to vapor results in a product that maintains its cellular or particle structure and certain desirable attributes such as flavor, aroma, volatile micronutrients, etc.

### Hardness, Dissolvability and Viscosity

Consumer preference for the final product is believed to be based on physical characteristics such as hardness, shape and dissolvability. While each characteristic is important, the correct balance between the three components is desired to optimize consumer appeal for the end product. Viscosity is defined as a measure of the resistance of substance to flow and is measured using a Brookfield viscometer with a Helipath stand with an F-T bar before the composition is aerated. It is believed that while the viscosity aids in holding the shape of a substance through aeration and shaping, the hardness aids in physical stability. The dissolvability, also a hardness measurement, is the change in hardness of a product in going from a dry to a wet state. With increased aeration, which aids in dissolvability, the hardness can be negatively affected. The compositions and methods of the present invention provide an optimum balance between viscosity, hardness and dissolvability to provide a physically stable product without the need for emulsifiers, viscosity agents or other chemical additives thereby improving consumer appeal for the product.

The composition of the end product may have a hardness value of from 0.5 to 8 pounds force, but preferably from 1.5 to 5.35 pounds force, with a dissolvability in the range of from 0.1 to 8 peak load.

The viscosity of the composition prior to aeration may range from 1 to 500,000 cp, dependent upon the temperature and speed of the viscometer used to measure the viscosity. In the preferred embodiment, the viscosity of the composition prior to aeration ranges from 30,000 to 60,000 cp at a 10 RPM speed of the spindle 6 in a Brookfield Viscometer, with the most preferred range from 35,000 to 50,000 cp. The viscosity of the aerated composition is not measurable by conventional viscosity testing with instruments such as the Brookfield Viscometer as it is approaching a solid substance and its visco/elastic attributes are significantly altered.

### Method of Making Aerated, Freeze Dried Yogurt

Yogurt production:

1. Pasteurized lowfat milk is transferred to a holding tank.

2. All ingredients (dry or liquid) (sugar, gelatin, starch, nonfat dry milk, and others (probiotics, prebiotics, vitamins, nutraceuticals, fruit, vegetables, grains, other functional/natural ingredients) are incorporated into the milk via addition to a hopper feeding a continuous liquid line to achieve initial hydration. The ingredients can also be incorporated via a high shear blender (such as Bredo Liqwifier) to achieve homogenous dispersion and initial hydration.

3. Once all ingredients have been incorporated, the mixture is preferably agitated for 30 minutes at 35-38 deg F.

4. The mixture is transferred to a pasteurization vat for thermal processing, preferably achieving and maintaining a minimum temperature of 165 deg F. at the end of a 30 minutes hold time. The temperature and hold time can vary depending upon mechanics of the process. For example, significant higher temperatures may be used and hold times could be increased to achieved desired reduction in microbiological activity or to achieve desired enzymatic action. After pasteurization, the mixture is passed through a two-step homogenizer Typical homogenization pressures are between 2,000 and 2,500 psi at a first stage and between 200 and 600 psi at a second stage.

5. After the hold time, the mixture is preferably cooled to 100-112 deg F. (and preferably between 105-108 deg F.) and is transferred to a culturing vat. At this point, the yogurt culture is added (preferably a freeze-dried culture) available through various vendors including Danisco, Cargill, Kerry BioSciences and others. The culture is blended with the pasteurized mix for 30-60 minutes, the mixing is stopped and the vat is maintained at 104-108 deg F. for 6-10 hours. Yogurt is allowed to acidify to pH 4.5 to 4.6, and is then agitated (broken) and cooled to 60 deg F. in the culture tank. Final pH will range from 4.1 - 4.4.

6. Yogurt is further cooled within the culturing vat by pumping glycol through the tank jacket, which lowers the temperature to 40-45 deg F. Pasteurized fruit puree, flavors and any desired color is then added. The mixture is blended with gentle agitation and recirculation for 10-15 minutes. The blended fruit yogurt is then preferably transferred to 50 gallon barrels or other desired container and is stored at 34-40 deg F.

### Production of Frozen Yogurt Pieces

7. The yogurt is conveyed/pumped from the 50 gallon barrels or other container preferably using a high shear pump which reduces the viscosity. The viscosities may range from 1 to 500,000 cp. The viscosity range of yogurt is typically between 30,000 to 60,000 cp which may be reduced via the shear pump to 1 cp to 50,000 cp, but preferably the viscosity is reduced to between 3,000 cp to 10,000 cp.

8. The shear pump deposits the yogurt into a scrape surface heat exchanger, preferably, with the capability to bubble air (oxygen) or other gases or liquids. A preferred scrape surface heat exchanger is a continuous ice, cream freezer, such as a APV Crepaco Ice Cream freezer, model no. W-1126. The ice cream freezer is connected to a suitable cooling source, such as liquid ammonia source, to maintain the mixing tempura at 24-34 deg F.

9. As the yogurt is slowly churned in the ice cream freezer, the viscosity of the yogurt increases as it is cooled entrapping or entraining air until the consistency of the yogurt becomes whipped, light and airy. The ability to bubble air (oxygen) or other gases or liquids speeds up the process of entrapping air or liquid between the particles.

10. The whipped or aerated yogurt is maintained at 28-32 deg F. as it is pumped into a depositor, where it is distributed to multiple nozzles which, via a metering device, deposits drops, dollops or other shapes of the aerated yogurt, preferably in the form of a large chocolate chip shape or other desired shape, directly onto a solid, stainless steel freezer belt. The preferred chocolate chip dollop has a diameter of 14-22 mm (preferably 17-20 mm), a height of 7-12 mm (preferably 8-10 mm), and a weight of 0.8-1.3 grams (preferably 1.0-1.1 g). Alternatively, the aerated yogurt could be molded, extruded or otherwise formed to achieve the desired shape.

11. The freezer belt conveys the deposited aerated yogurt into a freezer tunnel with air temperatures approximately −60 deg F., with high velocity air circulation. Dwell time in the tunnel is preferably between 2-4 minutes. The frozen aerated yogurt pieces exit the tunnel with an internal temperature between 0-10 deg F.

12. The frozen pieces are removed from the freezer belt and conveyed to a bulk case packer, where they are filled into large plastic totes and stored at 0 to −10 deg F. until freeze drying.

### Production of Freeze Dried Yogurt Pieces

13. The frozen aerated yogurt pieces are removed from the plastic totes while maintaining the temperature at −10 F to +10 F, preferably 0 deg F., and deposited on trays. The trays are loaded onto tray carrier for conveying to the freeze dryer, such as Niro/Atlas Ray 125 or other suitable freeze dryer. During the freeze drying process, the frozen aerated yogurt pieces are preferably subjected to a vacuum less than 6.1173 millibars to sublimate the frozen ice crystals. Vacuum for the freeze dryer may be achieved with an industrial pump which can have settings from 0.5 millibar to 5 millibar, preferable 1 millibar. The condensing system of the freeze dryer uses refrigerants such as ammonia to achieved desired condensing surfaces that range from +0 F to −50 F, preferably −40 F. The heating systems of the freeze dryer contains media such as water, oil, glycol, etc. within some sort of heating element to transfer heat to the product via radiant or conductive heat. Heating media temperatures can be from −30 F to +300 F depending on desired heat transfer to the product and product parameters.

From the initial temperatures ranging from −10 F to +10 F, the final product temperature ranges from +100 F to +140 F. The freeze drying cycle may range from 8 hours to 30 hours depending on product attributes and loading density. The final product moisture is from 0.5% to 5%.

14. After freeze-drying the dehydrated aerated yogurt pieces are packaged for distribution. The preferred packaging method is to nitrogen flush and vacuum seal the product in foil pouches or bags to achieve maximum shelf life.

The following composition based on the foregoing method can be prepared. The percentages listed are based on the total weight of the composition.

### AERATED, FREEZE-DRIED YOGURT EXAMPLE 1

| Ingredient | Percentage by Weight |
|---|---|
| Low fat milk | 79.99 |
| Sugar | 10.0 |
| Other (fruit, flavor, etc.) | 10.0 |
| Yogurt culture | 0.01 |

### Method of Making Aerated, Freeze Dried Fruit

### Pureed Fruit Production:

1. Raw fruit is received and undesired parts (stem, leaves, pit, etc.) are removed.

2. The raw fruit pieces are converted to liquid slurry by mashing, grinding, pressure, etc.

3. The pureed fruit can be frozen or packaged aseptically. Aseptically packaged fruit puree is thermally processed by heating to certain levels (from 140 F to 300 F) for certain length of time (from 5 seconds to 24 hours) to kill all organisms that would prove detrimental to shelf life. In the thermal processing of aseptic fruit puree certain volatiles (aromatic compounds, flavor compounds, etc.) can escape the fruit puree and be captured and reintroduced back into the fruit puree prior to packaging. In addition to standard fruit purees concentrated fruit purees can be produced by removing some of the water prior to packaging. Methods for concentrating include, but are not limited to, falling film evaporator, rising film evaporators, spinning cone extraction, centrifuge, air drying, etc. Liquid fruit purees can also be transferred to blending tanks by pumping where flavors and any other desired additives or coloring may be added. The mixture is blended with gentle agitation and recirculation for 10-15 minutes. The blended fruit puree is then aseptically processed or transferred to 50 gallon barrels or other desired container and frozen at −10 deg F. to 0 deg F.

### Production of Frozen Fruit Pieces

4. The fruit puree is conveyed/pumped from the 50 gallon barrels or other container preferably using a high shear pump which reduces the viscosity. The fruit puree viscosity may range from 1 to 500,000 cp. After reduction, the fruit puree may have a reduced viscosity between 1 cp to 50,000 cp, but preferably the reduced viscosity is between 3,000 cp to 10,000 cp.

5. The shear pump deposits the fruit puree into a scrape surface heat exchanger, preferably, with the ability to bubble air (oxygen) or other gases or liquids. A preferred scrape surface heat exchanger is a continuous ice cream freezer, such as a APV Crepaco Ice Cream freezer, model no. W-1126. The ice cream freezer is connected to a suitable cooling source, such as liquid ammonia source, to maintain the mixing tempura at 24-34 deg F.

6. As the fruit puree is slowly churned in the ice cream freezer, the viscosity of the puree increases as it is cooled entrapping or entraining air until its particle structure or matrix and porosity is similar to the cellular structure of the fruit in its natural state with the air bubbles entrapped between the particles representing cell like structures that, after freeze drying, will have the structure, texture and porosity similar to cellular structure within freeze dried fruit pieces.

7. The aerated fruit composition is maintained at 28-32 deg F. as it is pumped to a device to form/shape the aerated fruit into the desired shape. Such devices may include, but are not limited to, a depositor, extruder, or mold. The device to form/shape the aerated fruit composition is preferably disposed to convey the fruit pieces directly onto a solid, stainless steel freezer belt.

8. The freezer belt conveys the deposited aerated fruit into a freezer tunnel with air temperatures approximately −60 deg F., with high velocity air circulation. Dwell time in the tunnel is preferably between 2-4 minutes. The frozen aerated fruit pieces exit the tunnel with an internal temperature between 0-10 deg F.

9. The frozen aerated fruit pieces are removed from the freezer belt and conveyed to a bulk case packer, where they are filled into large plastic totes and stored at 0 to −10 deg F. until freeze drying.

### Production of Freeze Dried Fruit Pieces

13. The frozen aerated fruit pieces are removed from the plastic totes while maintaining the temperature at −10 F to +10 F, preferably 0 deg F., and deposited on trays. The trays are loaded onto tray carrier for conveying to the freeze dryer, such as Niro/Atlas Ray 125 or other suitable freeze dryer. During the freeze drying process, the frozen aerated fruit pieces are preferably subjected to a vacuum less than 6.1173 millibars to sublimate the frozen ice crystals. Vacuum for the freeze dryer may be achieved with an industrial pump which can have settings from 0.5 millibar to 5 millibar, preferable 1 millibar. The condensing system of the freeze dryer uses refrigerants such as ammonia to achieved desired condensing surfaces that range from +0 F to −50 F, preferably −40 F. The heating systems of the freeze dryer contains media such as water, oil, glycol, etc. within some sort of heating element to transfer heat to the product via radiant or conductive heat. Heating media temperatures can be from −30 F to +300 F depending on desired heat transfer to the product and product parameters.

From the initial temperatures ranging from −10 F to +10 F, the final product temperature ranges from +100 F to +140 F. The freeze drying cycle may range from 8 hours to 30 hours depending on product attributes and loading density. The final product moisture is from 0.5% to 5%.

14. After freeze-drying the dehydrated aerated fruit pieces are packaged for distribution. The preferred packaging method is to nitrogen flush and vacuum seal the product in foil pouches or bags to achieve maximum shelf life.

The following composition based on the foregoing method can be prepared. The percentages listed are based on the total weight of the composition.

### AERATED, FREEZE-DRIED FRUIT EXAMPLE 1

| Ingredient | Percentage by Weight |
|---|---|
| Fruit (strawberries, blueberries, | 80.0 |
| bananas, pineapple, etc.) | |
| Sugar | 10.0 |
| Other (starch, functional ingredients, etc.) | 10.0 |

It should be appreciated that the raw ingredient is preferably pureed and aerated until its particle structure or matrix and porosity is similar to the cellular structure of the raw ingredient in its natural state, whereby the air bubbles entrapped between the particles represent cell like structures. The aerated composition is then preferably molded and freeze-dried into a shape that is similar to the natural state of the raw ingredient. The resulting product has the structure, texture and porosity similar to cellular structure of the natural raw ingredient. For example pureed green beans could be aerated and deposited into a green bean mold, frozen and then freeze dried such that the end product would have the appearance and texture of a natural green bean. The same can be achieved for nearly any other raw ingredient. Thus, the foregoing process could be used with less desirable raw ingredients or broken or damaged raw ingredients that may not otherwise be suitable for freeze-drying thereby allowing the use of cheaper raw materials which savings can be passed onto consumers.

### Method of Making an Aerated, Dried Fruit Piece

1. A slurry is prepared from fruit puree and pectin or alginate such as previously described under steps 1-3 under “Method of Making an Aerated, Freeze Dried Fruit.”

2. The fruit slurry is pumped or deposited into a scrape surface heat exchanger where the fruit slurry is mechanically aerated by simultaneously cooling. Nitrogen gas is injected via a sparger to control bubble sizes.

3. After the fruit slurry is aerated and cooled to a suitable viscosity it can then be pumped to a depositor or similar apparatus for shaping.

4. The depositor places the fruit slurry in the desired shape on a stainless steel belt.

5. The fruit pieces are then transferred via stainless steel belt through a drying tunnel where the fruit pieces are dried to a moisture of 1-10%. The drying tunnel may be equipped to both cool and heat the product as well as operate at atmospheric conditions or modified atmospheric conditions including vacuum and pressure.

The following composition based on the foregoing method can be prepared. The percentages listed are based on the total weight of the composition.

### AERATED, DRIED FRUIT EXAMPLE 1

| Ingredient | Percentage by Weight |
|---|---|
| Fruit (strawberries, blueberries, | 80.0 |
| bananas, pineapple, etc.) | |
| Sugar | 10.0 |
| Other (starch, functional ingredients, etc.) | 10.0 |

As with the previously described Method of Making an Aerated, Freeze Dried Fruit, in this method, the raw ingredients are preferably pureed and aerated until the particle structure or matrix and porosity of the composition is similar to the cellular structure of the raw ingredient in its natural state, whereby the air bubbles entrapped between the particles represent cell like structures. The aerated composition is then preferably molded and dried into a shape that is similar to the natural state of the raw ingredient. The resulting product has the structure, texture and porosity similar to cellular structure of the natural raw ingredient. For example pureed strawberries could be aerated and deposited into a strawberry mold, and then dried such that the end product would have the appearance and texture of a natural strawberry. The same can be achieved for nearly any other raw ingredient. Thus, the foregoing process could be used with less desirable raw ingredients or broken or damaged raw ingredients that may not otherwise be suitable for drying thereby allowing the use of cheaper raw materials which savings can be passed onto consumers.

Various modifications to the preferred compositions and the general principles and features of the systems and methods described herein will be readily apparent to those of skill in the art. Thus, the present invention is not to be limited to the compositions, system and methods described but is to be accorded the widest scope consistent with the spirit and scope of the appended claims.

1. A method of producing frozen, aerated food product, said method comprising the steps of:
(a) providing a raw ingredient composition having a desired first viscosity;
(b) cooling and aerating the composition to a desired second viscosity with a desired amount of aeration;
(c) shaping the aerated composition;
(d) freezing the aerated composition.

2. The method of claim 1 further comprising the step of:
(e) freeze-drying the frozen aerated composition.

3. The method of claim 1 wherein the raw ingredient is a dairy or dairy substitute ingredient selected from the group consisting of: milk, milk powder, yogurt, skim milk, milk proteins, hydrolyzed milk proteins, soy proteins, whey proteins, and rice proteins.

4. The method of claim 1 wherein the raw ingredient is selected from the group consisting of fruits, vegetables, nuts, grains and meat.

5. The method of claim 1 further including:
pumping the raw ingredient through a shear pump to produce the desired first viscosity of step (a).

6. The method of claim 1 further including adding one or more functional ingredients before the aeration step (b), said functional ingredients selected from the group comprising: probiotics, prebiotics, nutraceuticals, plant extracts, animal extracts, herbs, fruits, vegetables, grains, proteins, amino acids, medicinal compounds and nutrition additives.

7. The method of claim 1 further including adding a viscosity enhancer before the aeration step (b), said viscosity enhancer selected from the group consisting of: starch, hydrocolloids such as carageenan, guar gum, locust bean gum, pectin and combinations thereof.

8. The method of claim 1 further including adding a gelatin before the aeration step (b)

9. The method of claim 1 further including adding alginate before the aeration step (b).

10. The method of claim 1 wherein the raw ingredient is between about 60% to 98% by weight of the pre-frozen aerated product.

11. The method of claim 2 wherein the freeze-dried, aerated product has a hardness value of from 0.5 to 8 pounds force.

12. The method of claim 1 further including adding at least one sugar before the aeration step (b).

13. The method of claim 1 further including adding at least one starch before the aeration step (b).

14. The method of claim 2 wherein the freeze-dried aerated product has a dissolvability in the range of from 0.1 to 8 peak load pounds.

15. The method of claim 1 wherein the first viscosity is between 1,000 to 500,000 cp.

16. The method of claim 3 wherein the composition is cooled and aerated in step (b) until a desired particle matrix and porosity of said composition is achieved.

17. The method of claim 1 wherein step (c) of shaping the aerated composition includes extruding the aerated composition into a desired shape.

18. The method of claim 1 wherein step (c) of shaping the aerated composition includes molding the aerated composition into a desired shape.

19. A method of producing a shaped aerated food product, said method comprising the steps of:
(a) providing a raw ingredient composition having a desired first viscosity;
(b) churning the composition while cooling to achieve a desired second viscosity with a desired amount of aeration;
(c) shaping the aerated composition.

20. The method of claim 21 further comprising the step of:
(d) drying the shaped aerated composition.

21. The method of claim 19 wherein the raw ingredient is a dairy or dairy substitute ingredient selected from the group consisting of: milk, milk powder, yogurt, skim milk, milk proteins, hydrolyzed milk proteins, soy proteins, whey proteins, and rice proteins.

22. The method of claim 19 wherein the raw ingredient is selected from the group consisting of fruits, vegetables, nuts, grains and meat.

23. The method of claim 19 further including:
pumping the raw ingredient through a shear pump to produce the desired first viscosity of step (a).

24. The method of claim 19 further including adding one or more functional ingredients before the churning step (b), said functional ingredients selected from the group comprising: probiotics, prebiotics, nutraceuticals, plant extracts, animal extracts, herbs, fruits, vegetables, grains, proteins, amino acids, medicinal compounds and nutrition additives.

25. The method of claim 19 further including adding a viscosity enhancer before the churning step (b), said viscosity enhancer selected from the group consisting of: starch, hydrocolloids such as carageenan, guar gum, locust bean gum, pectin and combinations thereof.

26. The method of claim 19 further including adding a gelatin before the churning step (b)

27. The method of claim 19 further including adding alginate before the churning step (b).

28. The method of claim 19 wherein the raw ingredient is between about 60% to 98% by weight of the pre-frozen aerated product.

29. The method of claim 20 wherein the dried, aerated product has a hardness value of from 0.5 to 8 pounds force.

30. The method of claim 1 further including adding at least one sugar before the churning step (b).

31. The method of claim 1 further including adding at least one starch before the churning step (b).

32. The method of claim 20 wherein the dried aerated product has a dissolvability in the range of from 0.1 to 8 peak load pounds.

33. The method of claim 19 wherein the first viscosity is between 1,000 to 500,000 cp.

34. The method of claim 19 wherein the composition is cooled and aerated in step (b) until a desired particle matrix and porosity of said composition is achieved.

35. A method of producing an aerated food product, said method comprising the steps of:
(a) providing a raw ingredient composition having a desired first viscosity;
(b) mechanically aerating the composition to a desired second viscosity with a desired amount of aeration;
(c) shaping the aerated composition.

36. The method of claim 35 further including cooling the composition while mechanically aerating the composition.

37. The method of claim 35 wherein step (b) of mechanically aerating the composition includes mixing the composition.

38. The method of claim 35 wherein step (b) of mechanically aerating the composition includes shearing the composition.

39. The method of claim 35 wherein step (b) of mechanically aerating the composition includes introducing a gas or flashable liquid.

40. The method of claim 39 wherein said gas is nitrogen.

41. The method of claim 39 wherein said gas is introduced with a sparger.

42. The method of claim 37 further including introducing a gas or flashable liquid while mixing the composition.

43. The method of claim 38 further including introducing a gas or flashable liquid while shearing the composition.

44. The method of claim 39 further including adjusting bubble size of said introduced gas or flashable liquid.

45. The method of claim 44 wherein said bubble size is adjusted by a sparger.

46. The method of claim 44 wherein said bubble size is adjusted by changing the temperature of said gas or flashable liquid.

47. The method of claim 35 wherein step (b) of mechanically aerating the composition includes reducing pressure on the composition to cause gas bubbles in said composition to expand.

48. The method of claim 35 wherein step (b) of mechanically aerating the composition includes introducing a gas or a flashable liquid into said composition while reducing pressure on the composition to cause said introduced gas bubbles in said composition to expand.

49. The method of claim 35 wherein step (b) of mechanically aerating the composition includes introducing a gas or flashable liquid into said composition while cooling the composition.

50. The method of claim 35 wherein step (b) of mechanically aerating the composition includes introducing a gas or flashable liquid into said composition while mixing the composition.

51. The method of claim 35 wherein step (b) of mechanically aerating the composition includes introducing a gas or flashable liquid into said composition while shearing the composition.

52. The method of claim 1 wherein the aerated composition is shaped into the natural raw form of the natural ingredient.

53. The method of claim 19 wherein the aerated composition is shaped into the natural raw form of the natural ingredient.

54. The method of claim 35 wherein the aerated composition is shaped the natural raw form of the natural ingredient.
